(19) United States
(12) Patent Application Publication
(10) Pub. No.: US 2025/0190979 A1
(43) Pub. Date: Jun. 12, 2025

(54) METHOD FOR MANAGING RIGHTS ASSOCIATED WITH AN OBJECT

(71) Applicant: BULGARI HORLOGERIE SA, Neuchâtel (CH)

(72) Inventors: Ennio Piccirillo, Firenze (IT); Davide Baldi, Lugano (CH)

(73) Assignee: BULGARI HORLOGERIE SA, Neuchâtel (CH)

(21) Appl. No.: 18/844,198

(22) PCT Filed: Mar. 14, 2023
(86) PCT No.: PCT/EP2023/056430

§ 371 Date: Sep. 5, 2024

(30) Foreign Application Priority Data
Mar. 14, 2022 (FR) FR2202221

(51) Int. Cl. G06Q 20/36; G06Q 20/38

(52) U.S. Cl. CPC G06Q 20/3678; G06Q 20/3829; G06Q 20/389

(57) ABSTRACT

The method for managing rights associated with an object (1), such as a timepiece (1) or an item of jewellery, includes creating a first digital token associated with a first right, in particular the right of ownership, to the object, the first digital token being stored and authenticated using a first blockchain protocol; creating a second digital token, in particular a non-fungible digital token, associated with a second right, in particular a right of access to digital content, in particular multimedia content, associated with the object, the second digital token being stored and authenticated using a second blockchain protocol: creating a smart contract binding the rights to the first and second digital tokens such that the right of ownership to one of the first and second digital tokens cannot be transferred without the right of ownership to the other of the first and second digital tokens.

### TECHNICAL FIELD OF THE INVENTION

The invention relates to a method for managing rights associated with an object. The invention further relates to the use of such an object in a method for managing rights attached to this s object. The invention also relates to a device for managing rights associated with such an object. The invention also relates to a program product for managing rights associated with such an object. The invention also relates to a data recording medium dedicated to implementing the method for managing rights associated with such an object. Lastly, the invention relates to a signal from a data medium, carrying such a computer program product.

### BACKGROUND ART

In certain fields, particularly in the field of luxury goods, there is a need to maintain a register of goods that have been manufactured and sold. There may also be an interest in documenting the chain of title throughout the lifespan of the goods. However, such documentation cannot be guaranteed once the product has been placed on the market. A register can only be maintained if the various owners of the product make themselves known to the owner of the register, and more particularly to the manufacturer maintaining the register.

### SUMMARY OF THE INVENTION

The aim of the invention is to provide a method for managing rights associated with an object that overcomes the aforementioned drawbacks and that improves on known prior-art managing methods. In particular, the invention provides a method for managing rights associated with an object that allows traceability and authenticity to be guaranteed while further allowing rights associated with goods and/or services annexed to the object to be managed.

According to the invention, a method allows rights associated with an object, such as a timepiece or item of jewelry, to be managed. The method comprises the following steps:
creating a first digital token associated with a first right, particularly an ownership right, to the object, the first digital token being stored and authenticated by virtue of a first blockchain protocol,
creating a second digital token, particularly a non-fungible digital token, associated with a second right, particularly a right of access to digital content, in particular multimedia content, associated with the object, the second digital token being stored and authenticated by virtue of a second blockchain protocol,
creating a smart contract linking the rights on the first and second digital tokens so that the ownership right on one of the first and second digital tokens cannot be transferred without the ownership right on the other of the first and second digital tokens.

The first blockchain protocol and second blockchain protocol are advantageously of the same type, or the first blockchain protocol and second blockchain protocol are advantageously the same blockchain protocol.

The smart contract may involve creating, by virtue of a blockchain protocol, a third digital token including information comprising:
at least one piece of information contained in the first digital token, particularly such as information on the object and/or a serial number of the object and/or an identifier of the transaction that created the first digital token and/or the date of activation of the certificate of authenticity and/or the date of sale of the product and/or an identifier of the first digital token, and
at least one piece of information contained in the second digital token, particularly such as an identifier of the second digital token.

Preferably, the smart contract is configured so that transferring the ownership right on the first digital token involves transferring the ownership right on the second digital token and/or transferring the ownership right on the third digital token, and/or transferring the ownership right on the second digital token involves transferring the ownership right on the first digital token and/or transferring the ownership right on the third digital token, and/or transferring the ownership right on the third digital token involves transferring the ownership right on the first digital token and/or transferring the ownership right on the second digital token.

The first digital token and/or second digital token may be associated with digital cryptoasset wallets, particularly the same digital cryptoasset wallet.

The digital cryptoasset wallet or one of the digital cryptoasset wallets may be associated with:
a public key, or
a code associated with the public key,
   the public key or code being written:
on the object, in particular on a component of a timepiece, in particular on a barrel or on a ratchet of a barrel of a timepiece, or
on a tangible medium sold with the object, or
in a digital document, such as a computer file or a message, particularly an MMS (acronym of Multimedia Messaging Service) or SMS (acronym of Short Messaging Service).

The public key or the code associated with the public key may be written by printing or by engraving or by adhesively bonding a label.

The code associated with the public key may be a machine-readable code, such as an NFC tag or a bar code, in particular such as a matrix code or QR code.

The digital cryptoasset wallet or one of the digital cryptoasset wallets may be associated with:
a private key, or
a code associated with the private key, the private key or code associated with the private key being written:
on a tangible medium annexed to the object, particularly on a card, on a label or on a physical document, and/or
in a digital document, such as a computer file or a message, particularly an MMS or SMS.

The code associated with the private key may be a machine-readable code, such as an NFC tag or a bar code, in particular such as a matrix code or QR code.

The invention also relates to use of an object or of a tangible medium annexed to the object and/or of an accessory, particularly of a timepiece, in particular of a barrel or ratchet of a barrel of a timepiece, as a medium for a public key or code associated with a public key of a digital cryptoasset wallet.

According to the invention, a device, particularly a distributed-computing architecture, allows rights associated with an object to be managed, the device comprising hardware and/or software elements implementing the method defined above, particularly hardware and/or software elements designed to implement the method defined above.

According to the invention, a device comprises means for implementing steps of the method defined above.

According to the invention, a computer program product comprises program code instructions recorded on a computer-readable medium for implementing the steps of the method defined above when said program is run on a computer.

The invention also relates to a computer program product downloadable from a communication network and/or recorded on a data medium that is readable by a computer and/or executable by a computer. The program product comprises instructions that, when the program is executed by the computer, lead the latter to implement steps of the method defined above.

The invention further relates to a computer-readable data recording medium on which is recorded a computer program comprising program code instructions for implementing the method defined above.

The invention further relates to a computer-readable recording medium comprising instructions which, when they are executed by a computer, cause the latter to implement steps of the method defined above.

The invention further relates to a signal from a data medium, carrying the computer program product defined above.

### BRIEF DESCRIPTION OF THE DRAWINGS

Subjects, features and advantages of the present invention are described in detail in the following description of one particular embodiment, which is given non-limitingly, with reference to the appended figures.

FIG. 1 is a view of a timepiece the rights to which are managed according to one mode of execution of the method according to the invention.

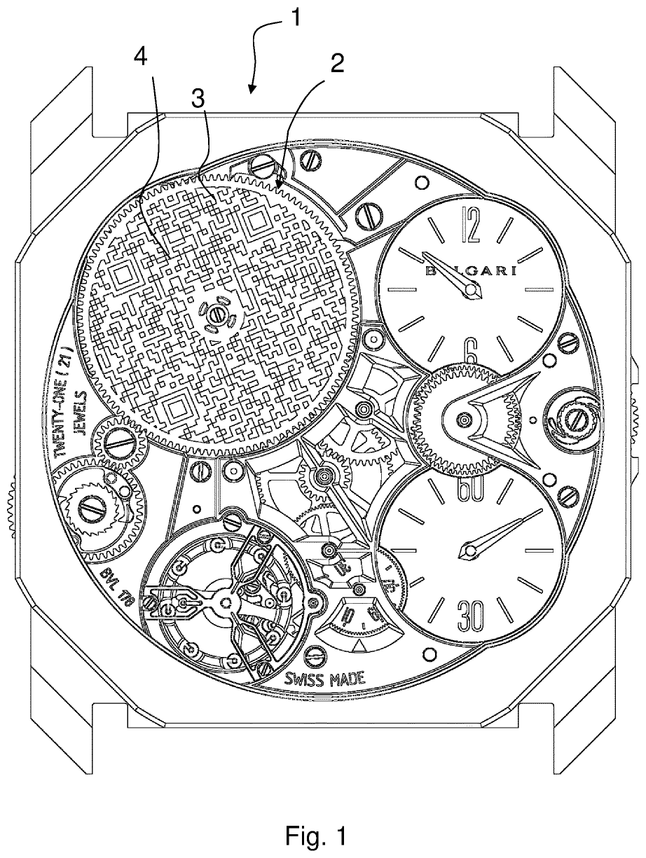

### DETAILED DESCRIPTION OF PARTICULAR EMBODIMENTS

The mode of execution of the managing method described below is explained in the context of application to an object 1 that is a timepiece 1. However, this method may be applied to any type of physical or intangible object, product or service. It may particularly also be applied to an item of jewelry.

The object is the main element rights to which are managed according to the method. The object may be marketed with an annexed element or auxiliary element that may also be of any type, such as a physical or intangible object, product or service.

In the described embodiment, while the main element is the timepiece, the auxiliary element comprises a service allowing access to data, particularly multimedia data that may contain images, audio content, and videos. For example, these data may chart the history of the creative project that brought the object to market. For example, these data may contain interviews with those involved in the project, such as an interview with an artistic director or an interview with a technical director addressing the owner of the timepiece directly.

The auxiliary element may also contain a digital or physical work of art sold with the timepiece and produced for example by an artist who collaborated with the manufacturer, and in particular who collaborated with the manufacturer in the process of creating the timepiece. The auxiliary element may also be an accessory object such as a display case for the timepiece.

Once the main element (for example, the object consisting of the timepiece) and the auxiliary element (for example, the service allowing access to data) have been produced by the manufacturer, a mode of execution of the method that is the subject of the invention is implemented.

The method allows rights to the main element to be managed. In particular, it is possible to manage the right of ownership to the main element. This ownership right may be divided into bare-ownership and usufruct. Management of any other right associated with the main element may be envisioned.

The method also allows rights to the auxiliary element to be managed. In particular, it is possible to manage the right to ownership of the auxiliary element. This ownership right may be divided into bare-ownership and usufruct. Management of any other right associated with the auxiliary element may be envisioned. These rights to the auxiliary element may be considered rights associated with the main element, the auxiliary element being associated with the main element.

The association between the auxiliary element and the main element may be of any nature, particularly functional, commercial, conceptual, or artistic. The association may further only be the consequence of implementation of the rights-managing method.

In a first step of the managing method, a first digital token associated with a first right, particularly an ownership right, to the timepiece is created or minted.

For example, the first digital token is a non-fungible token (NFT). The first digital token is stored and authenticated by virtue of a first blockchain protocol. For example, the first protocol is the blockchain protocol AURA.

In a second step of the managing method, a second digital token associated with a second right, particularly a right of access to digital content, in particular multimedia content, associated with the timepiece, is created or minted. As seen above, the second right may be a right to an auxiliary element. For example, the second digital token is a non-fungible token. The second digital token is stored and authenticated by virtue of a second blockchain protocol. The second protocol is for example the blockchain protocol POLYGON.

For example, the second right may be a right of access to digital content hosted on an internet site belonging to the manufacturer. The second right may therefore be a usufruct right to the website, while bare-ownership of the website is retained by the manufacturer.

The first blockchain protocol and second blockchain protocol may be of the same type, or indeed the first blockchain protocol and second blockchain protocol may be the same blockchain protocol.

The second step may be implemented in various ways.

For example, in a first mode of execution, the manufacturer triggers the operation of minting the second digital token as soon as the timepiece is finished, or when the timepiece of the manufacturer is sold to the first customer or first owner.

For example, in a second mode of execution, it is the first customer or first owner who triggers minting of the second digital token after she or he has taken possession of the timepiece.

In order to implement the second mode of execution:
a public key, or
a code associated with the public key, is written on the timepiece 1, in particular on a component 2 of the timepiece, in particular on a barrel 2 or on a ratchet 3 of a barrel 2 of the timepiece 1.

Alternatively, the timepiece may be supplied with a tangible medium such as a document, label, certificate, display case or any accessory on which the public key or code associated with the public key is written. Also alternatively, the timepiece may be supplied with a digital document, such as a computer file or a message, particularly an MMS or SMS, containing the public key or the code associated with the public key. This digital document may be handed over or sent upon purchase of the timepiece.

In addition, during the sale of the timepiece,
a private key, or
a code associated with the private key, may be supplied with a tangible medium such as a document, label, certificate, display case or any accessory on which the private key or code associated with the private key is written. Alternatively, the timepiece may be supplied with a digital document, such as a computer file or a message, particularly an MMS or SMS, containing the private key or the code associated with the private key. This digital document may be handed over or sent upon purchase of the timepiece. Preferably, delivery of the private key or code associated with the private key is secure. For example, when the private key or code associated with the private key is affixed to a document or more generally to any physical medium, it is covered with a coating masking it so that only the first owner will be able to see it after removing the coating.

Either or both of the keys and/or either or both of the codes associated with the keys may be written by printing or by engraving or adhesively bonding a label.

Preferably, either or both of the codes associated with the keys is a code readable via radio-frequencies or optically by a machine, such as an NFC tag (NFC standing for Near-Field Communication) or a bar code, in particular a bar code such as a matrix code or QR code.

Thus, after purchase of the timepiece, the first owner of the timepiece may, by having access to the public key and private key, trigger minting of the second digital token. To do this, she or he may navigate to a dedicated website and enter the public and private keys to start minting the second digital token.

Upon creation, the first and second digital tokens are associated with one or two digital cryptoasset wallets. They are upon creation associated with a digital wallet of the first owner or transferred from a digital wallet of the manufacturer to a digital wallet of the first owner when the timepiece is sold. The first digital token and the second digital token may be associated with different digital cryptoasset wallets. Advantageously, the first digital token and the second digital token may be associated with the same digital cryptoasset wallet.

The public and private keys mentioned above are advantageously the public and private keys of the digital cryptoasset wallet of the first owner containing, after sale of the timepiece of the manufacturer to the first owner, the first digital token and the second digital token.

Advantageously, in a third step of the managing method, a smart contract linking the rights on the first and second digital tokens is created so that the ownership right on one of the first and second digital tokens cannot be transferred without the ownership right on the other of the first and second digital tokens. In other words, the first and second digital tokens cannot be transferred without each other. Also preferably, assuming that the first and second digital tokens are originally associated with a first digital wallet, they may only be transferred together to be associated with a second digital wallet following transfer.

Preferably, the smart contract involves creating or minting, by virtue of a third blockchain protocol, a third digital token. The third blockchain protocol is preferably the same protocol as the first blockchain protocol or second blockchain protocol.

The third digital token advantageously contains information comprising:
at least one piece of information contained in the first digital token, particularly such as information on the timepiece and/or a serial number of the timepiece and/or an identifier of the transaction that created the first digital token and/or the date of activation of the certificate of authenticity and/or the date of sale of the timepiece and/or an identifier of the first digital token, and
at least one piece of information contained in the second digital token, particularly such as an identifier of the second digital token.

Alternatively, the first digital token and the second digital token (and optionally the third digital token) may be created simultaneously or almost simultaneously. In such a case, the first digital token may be created so as to include a datum relative to the second digital token, and the second digital token may be created so as to include a datum relative to the first digital token. Thus, the first and second tokens may be linked upon creation.

Preferably, the smart contract is configured so that:
transferring the ownership right on the first digital token involves transferring the ownership right on the second digital token and/or transferring the ownership digital right on the third token, and/or
transferring the ownership right on the second digital token involves transferring the ownership right on the first digital token and/or transferring the ownership right on the third digital token, and/or
transferring the ownership right on the third digital token involves transferring the ownership right on the first digital token and/or transferring the ownership right on the second digital token.

In practice, when transfer of one of the digital tokens from one digital cryptoasset wallet to another digital cryptoasset wallet is triggered, transfer of the other of the digital tokens or the other digital tokens is triggered automatically. Advantageously, in a software application allowing this transfer, when transfer of one of the digital tokens is requested, the application sends a message alerting to the consequences of the transfer on the other digital tokens.

Also advantageously, the smart contract may be configured to limit transfer of the one or more digital tokens, for example in order to:
make the transfer of the one or more digital tokens conditional on authorization by a third party, such as the manufacturer,
limit the frequency of transfer of the one or more digital tokens, for example to limit the transfer of the digital tokens to one transfer per year,
prohibit the transfer of the one or more digital tokens.

In particular, either of these limitations may be implemented in the event of loss or theft of the timepiece.

In the event of prohibition of the transfer of the one or more digital tokens, provision may be made for it to be the entirety of the digital cryptoasset wallet containing the digital tokens that is able to be transferred from one owner to another.

By virtue of the methods described above, it is possible to manage the rights to a main element such as a timepiece. In particular, it is possible to authenticate and trace various past transactions on the blockchain protocols.

Advantageously, all the transactions on the blockchain protocols may be saved by the manufacturer. To this end, particularly, the manufacturer may manage network nodes of the architecture allowing the processing operations used to construct the blockchains involved in storage and authentication of the digital tokens to be carried out.

It will be noted that the code associated with the public key and affixed to the timepiece itself is advantageously used by the owner to connect to a website offering the aforementioned digital content. For example, read-out, using a smartphone, of the QR code affixed to the timepiece, allows the phone to be automatically connected to the website offering the content.

The invention also relates to the use of an object and/or of a tangible medium annexed to the object and/or of an accessory, particularly of the timepiece 1, in particular of the barrel 2 or ratchet 3 of the barrel 2 of the timepiece 1, as a medium for the public key or code 4 associated with the public key of the digital cryptoasset wallet.

An embodiment of a device, particularly of a distributed-computing architecture, allows rights associated with the object to be managed. This embodiment comprises hardware and/or software elements implementing the method described above.

An embodiment of a computer program product comprises program code instructions recorded on a computer-readable medium for implementing the steps of the method described above when said program is run on a computer.

An example of a program product code used to implement the described managing method is detailed below.

The invention further relates to a computer-readable data recording medium on which is recorded a computer program comprising program code instructions for implementing the method described above.

The invention further relates to a signal from a data medium, carrying the computer program product described above.

1. A method for managing rights associated with an object, the method comprising:
creating a first digital token associated with a first right to the object, the first digital token being stored and authenticated by virtue of a first blockchain protocol,
creating a second digital token associated with a second right associated with the object, the second digital token being stored and authenticated by virtue of a second blockchain protocol,
creating a smart contract linking the rights on the first and second digital tokens so that the ownership right on one of the first and second digital tokens cannot be transferred without the ownership right on the other of the first and second digital tokens.

2. The managing method as claimed in claim 1, wherein
the first blockchain protocol and second blockchain protocol are of a same type, or
the first blockchain protocol and second blockchain protocol are a same blockchain protocol.

3. The managing method as claimed in claim 1, wherein the smart contract involves creating, by virtue of a blockchain protocol, a third digital token including information comprising:
at least one piece of information contained in the first digital token, and
at least one piece of information contained in the second digital token.

4. The managing method as claimed in claim 1, wherein the smart contract is configured so that:
transferring the ownership right on the first digital token involves transferring the ownership right on the second digital token and/or transferring the ownership right on the third digital token, and/or
transferring the ownership right on the second digital token involves transferring the ownership right on the first digital token and/or transferring the ownership right on the third digital token, and/or
transferring the ownership right on the third digital token involves transferring the ownership right on the first digital token and/or transferring the ownership right on the second digital token.

5. The managing method as claimed in claim 1, wherein the first digital token and/or second digital token are associated with a digital cryptoasset wallet or with digital cryptoasset wallets.

6. The managing method as claimed in claim 5, wherein the digital cryptoasset wallet or one of the digital cryptoasset wallets is associated with:
a public key, or
a code associated with the public key,
the public key or code being written:
on the object, or
on a tangible medium sold with the object, or
in a digital document.

7. The managing method as claimed in claim 6, wherein the public key or the code associated with the public key is written by printing or by engraving or by adhesively bonding a label.

8. The managing method as claimed in claim 6, wherein the code associated with the public key is a machine-readable code.

9. The managing method as claimed in claim 1, wherein the digital cryptoasset wallet or one of the digital cryptoasset wallets is associated with:
a private key, or
a code associated with the private key,
the private key or code associated with the private key being written:
on a tangible medium annexed to the object, and/or
in a digital document.

10. The managing method as claimed in claim 9, wherein the code associated with the private key is a machine-readable code.

11. (canceled)

12. A device allowing rights associated with an object to be managed, the device comprising hardware and/or software elements implementing the method as claimed in claim 1.

13. A non-transitory computer program product comprising program code instructions recorded on a computer-readable medium for implementing the method as claimed in claim 1 when the program is run on a computer.

14. The non-transitory computer program product as claimed in claim 13, which includes a computer-readable data recording medium on which is recorded a computer program comprising the program code instructions.

15. The managing method as claimed in claim 1, wherein the object is a timepiece or an item of jewelry.

16. The managing method as claimed in claim 1, wherein the first right is an ownership right to the object and the second right is a right of access to digital content.

17. The managing method as claimed in claim 1, wherein the second digital token is a non-fungible digital token.

18. The managing method as claimed in claim 3, wherein
the at least one piece of information contained in the first digital token is information on the object and/or a serial number of the object and/or an identifier of the transaction that created the first digital token and/or a date of activation of the certificate of authenticity and/or a date of sale of the product and/or an identifier of the first digital token, and
the at least one piece of information contained in the second digital token is an identifier of the second digital token.

19. The managing method as claimed in claim 5, wherein the first digital token and/or second digital token are associated with a same digital cryptoasset wallet.

20. The managing method as claimed in claim 6, wherein the object is a timepiece and the public key or code is written on a barrel or a ratchet of a barrel of the timepiece.

21. The managing method as claimed in claim 6, wherein the public key or code is written in a digital document which is a computer file or a message.
